(19) United States
(12) Patent Application Publication
(10) Pub. No.: US 2010/0311343 A1
(43) Pub. Date: Dec. 9, 2010

(54) HIERARCHICAL MODULATION FOR ACCURATE CHANNEL SOUNDING

(76) Inventor: Arvind Vijay KEERTHI, Bangalore (IN)

Correspondence Address: PILLSBURY WINTHROP SHAW PITTMAN, LLP, P.O. BOX 10500, MCLEAN, VA, 22102, US

(21) Appl. No.: 12/551,179

(22) Filed: Aug. 31, 2009

(30) Foreign Application Priority Data
Jun. 7, 2009 (IN) 1601/CHE/2009

(51) Int. Cl. H04B 15/00

(52) U.S. Cl. 455/63.1

(57) ABSTRACT

Method and apparatus for improving the channel estimate of a communication channel between a first station and a second station, while reducing the amount of reserved bandwidth for pilot tones. Hierarchical modulation is used to augment pilot density without sacrificing throughput. At the first station, a digital information stream may be split into a base stream and an enhancement stream, wherein the base stream and the enhancement stream combined form a hierarchical signal. At the second station, the base stream may be first recovered, and recovered base stream serves as a pilot for the enhancement stream. Thus the base stream, which is a subset of the total transmitted information, may be made to perform the channel-sounding function for the enhancement stream.

### CROSS-REFERENCE TO RELATED APPLICATION

None

### BACKGROUND

Multiple Input Multiple Output (“MIMO”) is a technique by which information is transmitted from an array of multiple antennas, and is also received by an array of multiple antennas. The signals to or from some or all of the individual antennas are combined to form a composite array response. The MIMO technique achieves a high level of reliability using a moderate amount of power.

### SUMMARY

An embodiment relates to a method comprising splitting a digital information stream into a base stream and an enhancement stream, encoding the base stream and the enhancement stream separately to form an encoded base stream and an encoded enhancement stream, and combining the encoded base stream and the encoded enhancement stream to form a hierarchical signal.

The method could further comprise providing a first pilot reference, combining the first pilot reference with the hierarchical signal to produce a combined signal, and transmitting the combined signal.

The method could further comprise modulating the encoded base stream and the encoded enhancement stream separately to form a modulated encoded base stream and a modulated encoded enhancement stream.

The method could further comprise attenuating the modulated encoded enhancement stream to form an attenuated modulated encoded enhancement stream, wherein the attenuated modulated encoded enhancement stream has a lower power than the modulated encoded base stream, combining the modulated encoded base stream with the attenuated modulated encoded enhancement stream to produce the hierarchical signal, providing a first pilot reference, combining the first pilot reference with the hierarchical signal to produce a combined signal, and transmitting the combined signal.

Another embodiment relates to a method comprising receiving a combined signal comprising a first pilot reference and a hierarchical signal, the hierarchical signal comprising a modulated encoded base stream and a modulated encoded enhancement stream, calculating a first channel estimate based on the first pilot reference, recovering a base stream from the combined signal based on the first channel estimate, calculating a second channel estimate based on the base stream as a second pilot reference, combining the first channel estimate and the second channel estimate to produce a third channel estimate, and recovering an enhancement stream from the combined signal based on the third channel estimate.

The method could further comprise demodulating and decoding the modulated encoded base stream from the combined signal, re-encoding the base stream to form a re-encoded base stream, and re-modulating the re-encoded base stream to form a re-modulated re-encoded base stream, wherein calculating the second channel estimate further comprises calculating the second channel estimate based on the re-modulated re-encoded base stream as a second pilot reference.

The method could further comprise removing the re-modulated re-encoded base stream from the combined signal, and demodulating and decoding the modulated encoded enhancement stream from the combined signal.

Calculating the first channel estimate may comprise applying a frequency domain interpolation to the first pilot reference to calculate the first channel estimate.

Calculating the second channel estimate may comprise applying a frequency domain interpolation to the re-modulated re-encoded base stream to calculate the second channel estimate.

The first channel estimate and the second channel estimate may be combined using the following equation: ĉ=βĉ_{P}+(1−β)ĉ_{D}, where |β|<1, wherein, ĉ is the third channel estimate, ĉ_{P} is the first channel estimate, ĉ_{P} is the second channel estimate, and β is a parameter that depends on a density of the first pilot reference and a power level of the modulated encoded enhancement stream.

Another embodiment relates to an apparatus, comprising a switch configured to split a digital information stream into a base stream and an enhancement stream, a first encoder configured to encode the base stream to form an encoded base stream, a second encoder configured to encode the enhancement stream to form an encoded enhancement stream, and a processor configured to combine the encoded base stream and the encoded enhancement stream to form a hierarchical signal, wherein the apparatus is configured to transmit a radio signal.

The apparatus could further comprise a processor configured to combine a first pilot reference with the hierarchical signal to produce a combined signal, and at least one apparatus configured to transmit the combined signal.

The apparatus could further comprise a first modulator configured to modulate the encoded base stream to form a modulated encoded base stream, and a second modulator configured to modulate the encoded enhancement stream to form a modulated encoded base stream.

The apparatus could further comprise an attenuator configured to attenuate the modulated encoded enhancement stream to form an attenuated modulated encoded enhancement stream, wherein the attenuated modulated encoded enhancement stream has a lower power than the modulated encoded base stream, a summer configured to combine the modulated encoded base stream with the attenuated modulated encoded enhancement stream to produce the hierarchical signal, a processor configured to combine a first pilot reference with the hierarchical signal to produce a combined signal, and at least one apparatus configured to transmit the combined signal.

Another embodiment relates to an apparatus comprising at least one apparatus configured to receive a combined signal comprising a first pilot reference and a hierarchical signal, the hierarchical signal comprising a modulated encoded base stream and a modulated encoded enhancement stream, a channel estimator configured to (a) calculate a first channel estimate based on the first pilot reference, (b) calculate a second channel estimate based on a base stream as a second pilot reference, wherein the base stream is recovered from the combined signal based on the first channel estimate, and (c) combine the first channel estimate and the second channel estimate to produce a third channel estimate, wherein an enhancement stream is recovered from the combined signal based on the third channel estimate, wherein the apparatus is configured to receive a radio signal.

The apparatus could further comprise a base stream demodulator configured to demodulate the modulated encoded base stream from the combined signal to form a demodulated encoded base stream, a base stream decoder configured to decode the demodulated encoded base stream to form a demodulated decoded base stream, a base stream re-encoder configured to re-encode the demodulated decoded base stream to form a re-encoded base stream, and a base stream re-modulator configured to re-modulate the re-encoded base stream to form a re-modulated re-encoded base stream, wherein the channel estimator is configured to calculate the second channel based on the re-modulated re-encoded base stream as a second pilot reference.

The apparatus could further comprise a summer configured to subtract the re-modulated re-encoded base stream from the combined signal, enhancement stream demodulator configured to demodulate the modulated encoded enhancement stream from the combined signal to form a demodulated encoded enhancement stream, and an enhancement stream decoder configured to decode the demodulated encoded enhancement stream to form a demodulated decoded enhancement stream.

The channel estimator may be configured to calculate the first channel estimate by applying a frequency domain interpolation to the first pilot reference.

The channel estimator may be configured to calculate the second channel estimate by applying a frequency domain interpolation to the re-modulated re-encoded base stream.

The first channel estimate and the second channel estimate may be combined using the following equation: ĉ=βĉ_{P}+(1−β)ĉ_{D}, where |β|<1, wherein, ĉ is the third channel estimate, ĉ_{P} is the first channel estimate, ĉ_{P} is the second channel estimate, and β is a parameter that depends on a density of the first pilot reference and a power level of the modulated encoded enhancement stream.

Another embodiment relates to a computer readable tangible medium comprising computer executable instructions for calculating a first channel estimate based on a first pilot reference of a combined signal, the combined signal comprising the first pilot reference and a hierarchical signal, the hierarchical signal comprising a modulated encoded base stream and a modulated encoded enhancement stream, recovering a base stream from the combined signal based on the first channel estimate, calculating a second channel estimate based on the base stream as a second pilot reference, combining the first channel estimate and the second channel estimate to produce a third channel estimate, and recovering an enhancement stream from the combined signal based on the third channel estimate.

The instructions may further comprise instructions for demodulating and decoding the modulated encoded base stream from the combined signal, re-encoding the base stream to form a re-encoded base stream, and re-modulating the re-encoded base stream to form a re-modulated re-encoded base stream, wherein instructions for calculating the second channel estimate further comprise instructions for calculating the second channel estimate based on the re-modulated re-encoded base stream as a second pilot reference.

The instructions may further comprise instructions for removing the re-modulated re-encoded base stream from the combined signal, and demodulating and decoding the modulated encoded enhancement stream from the combined signal.

The instructions for calculating the first channel estimate may further comprise instructions for applying a frequency domain interpolation to the first pilot reference to calculate the first channel estimate.

The instructions for calculating the second channel estimate may further comprise instructions for applying a frequency domain interpolation to the re-modulated re-encoded base stream to calculate the second channel estimate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

FIGS. 1A-1B show block diagrams of an example MIMO-OFDM transmitter and receiver.

FIG. 2 shows a flow diagram of a method to perform an embodiment.

FIG. 3 shows a block diagram of a MIMO-OFDM transmitter in accord with an embodiment.

FIG. 4 shows a block diagram of a MIMO-OFDM receiver in accord with an embodiment.

FIG. 5 shows a block diagram illustrating an example computing device in accord with an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

An embodiment relates to methods, apparatus, computer programs and/or systems related to improved spectral efficiency of communications systems that employ pilot signals.

MIMO is often deployed in conjunction with Orthogonal Frequency Division Multiplex (“OFDM”). OFDM refers to the modulation plan and frequency plan of the carrier signals on the antenna arrays. OFDM is a frequency-division multiplexing (FDM) scheme utilized as a method of digital multi-carrier modulation. A large number of closely-spaced orthogonal sub-carriers are used to carry data, thereby spanning a large portion of the available bandwidth. The data is divided into several parallel data streams or channels, one for each sub-carrier. Each sub-carrier is modulated with a conventional modulation scheme (e.g., QAM or PSK, etc.) at a low symbol rate, while maintaining total data rates similar to conventional single-carrier modulation schemes in the same bandwidth. An advantage of OFDM over single-carrier schemes is its ability to cope with severe channel conditions without complex equalization filters.

An example MIMO-OFDM system reserves about 10% of the available bandwidth per transmit antenna to provide for pilot tones. Accordingly, a MIMO-OFDM system having more than four or so transmit antennas would have 40% of bandwidth reserved for “pilot overhead,” reducing throughput by the same amount and inefficiently using the available bandwidth.

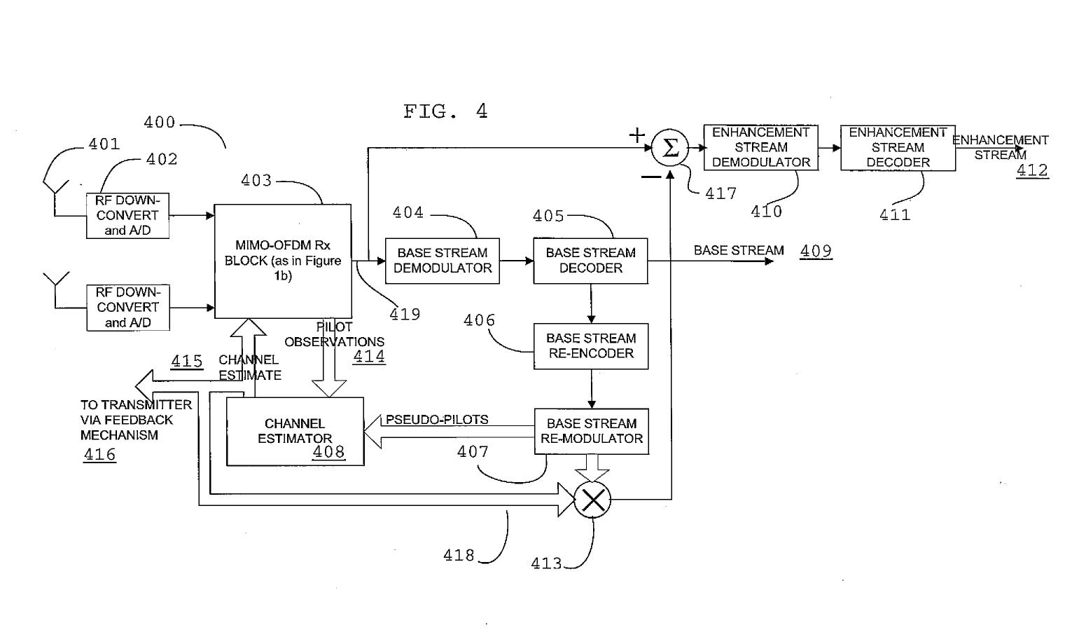

An embodiment herein reduces the amount of reserved bandwidth by using hierarchical modulation to augment pilot density without sacrificing throughput. Pilot density refers to the number of pilot sub-carriers/tones divided by total number of sub-carriers (i.e., fraction of bandwidth reserved for pilot tones). Each traffic-bearing tone carries two streams of traffic: a “base” stream and an “enhancement” stream. The “base” stream and “enhancement” stream may also be referred to as “High Priority” and “Low Priority” streams, respectively. Each stream may be encoded using distinct forward error correction (“FEC”) encoders. The base stream may be first recovered at the receiver as described below in relation to FIG. 4, and once the base stream is recovered it serves as a pilot for the enhancement stream. Thus the base stream, which is a subset of the total transmitted information, may be made to perform the channel-sounding function for the enhancement stream. Channel sounding refers to the measurement of the channel's impulse response (i.e., measurement of the channel's transfer function). The base stream may alternatively be referred to as a “pseudo-pilot stream”.

Usage of the pseudo-pilot stream allows pilot overhead to be contained to less than approximately 10% of total bandwidth, even if the number of transmit antennas is as high as at least eight. This technique may also be applicable to single-input, single-output (“SISO”) antenna systems, where pilot overhead is a lesser concern. Usage of pseudo-pilot stream in SISO systems allows for an increase in channel-sounding accuracy, which in turn allows for a reduction in transmit power by approximately 50% (i.e., a 3 dB improvement) without significantly sacrificing performance. This technique is similarly applicable to multiple-input, single output (“MISO”) and single-input, multiple-output (“SIMO”) antenna systems.

At least some transmit-receive antenna pairs of a MIMO system may be characterized by an a priori unknown channel response. This channel response is a complex quantity, and represents the amplitude and phase shift experienced by a symbol traversing a transmit-receive antenna pair. The N² channels of an N×N MIMO system generally are estimated before recovery of symbols is possible by the receiver. Furthermore, at least some of the N² channels may exhibit a non-flat frequency response, so that a wide band signal needs knowledge or an estimate of the channel, at least at frequencies separated by one coherence bandwidth.

In the description below, the number of transmit antennas is denoted by a, the number of receive antennas is denoted by b, and the number of sub-carriers is denoted by N_{C}. The m-th sub-carrier is characterized by a b×a channel matrix C(m).

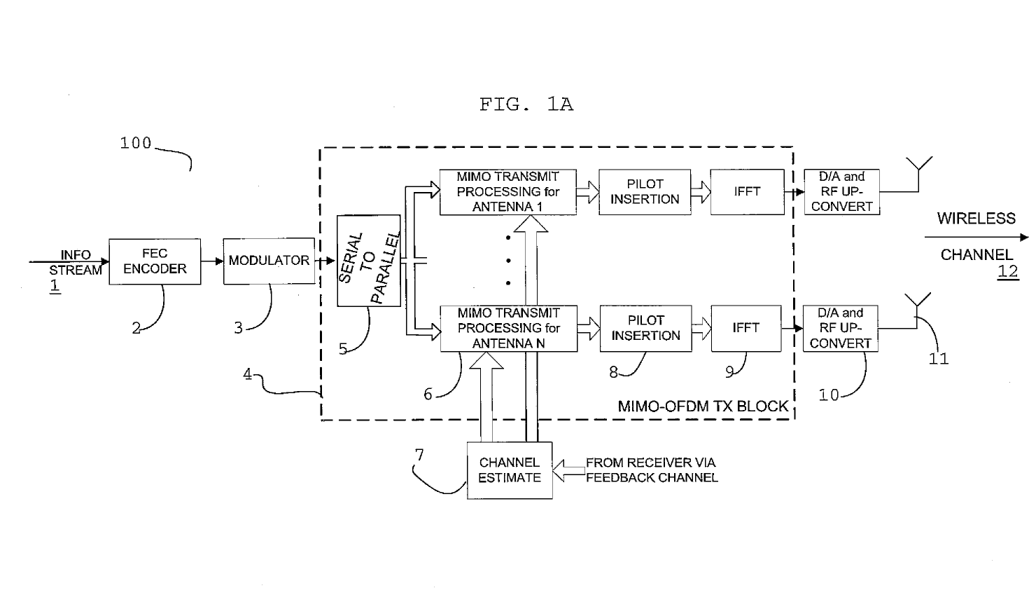

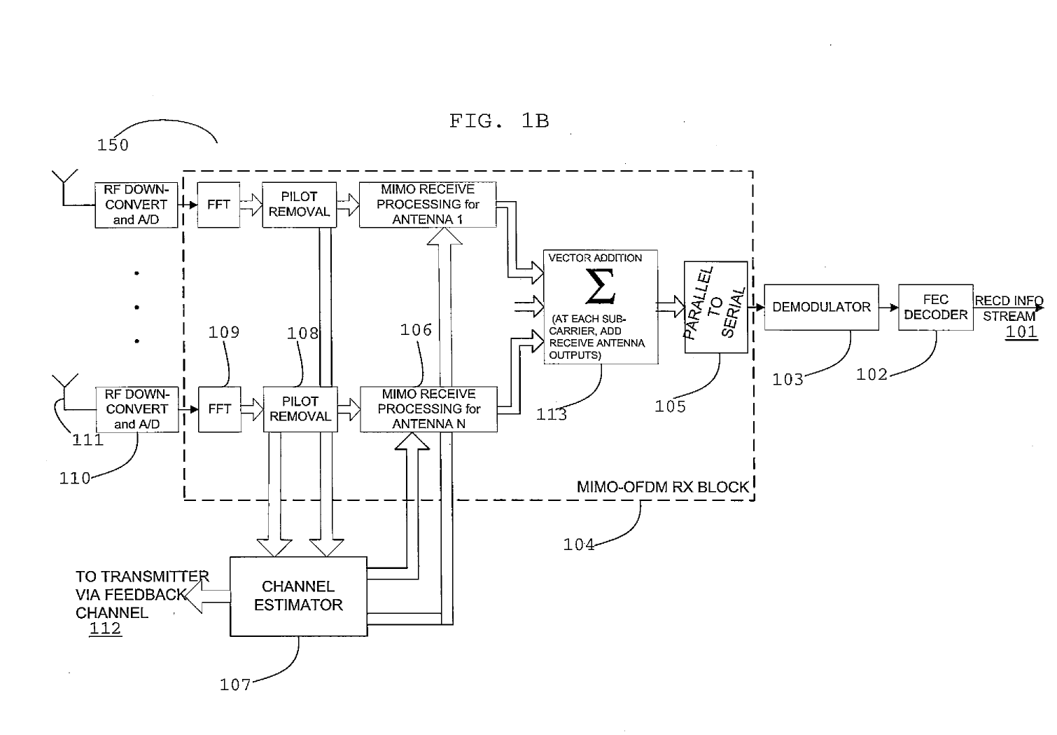

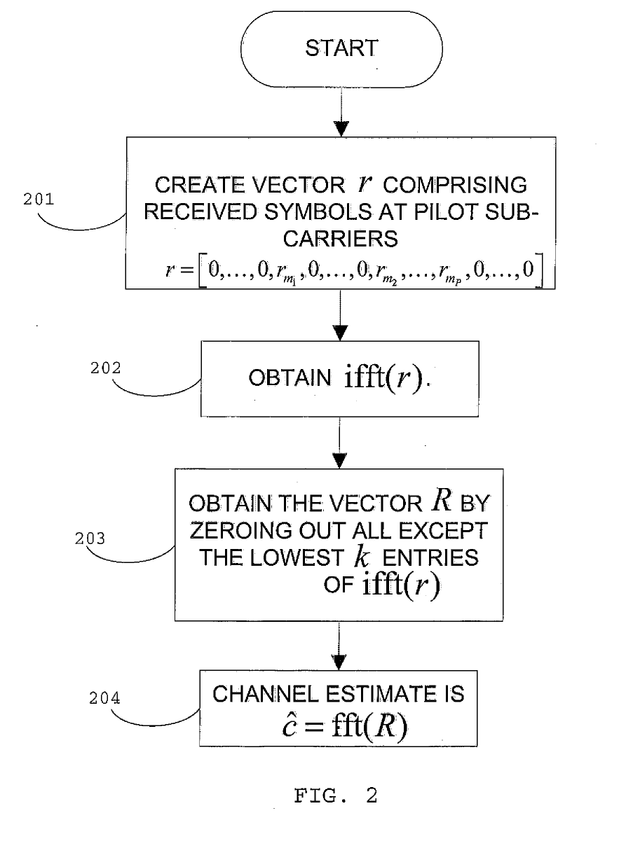

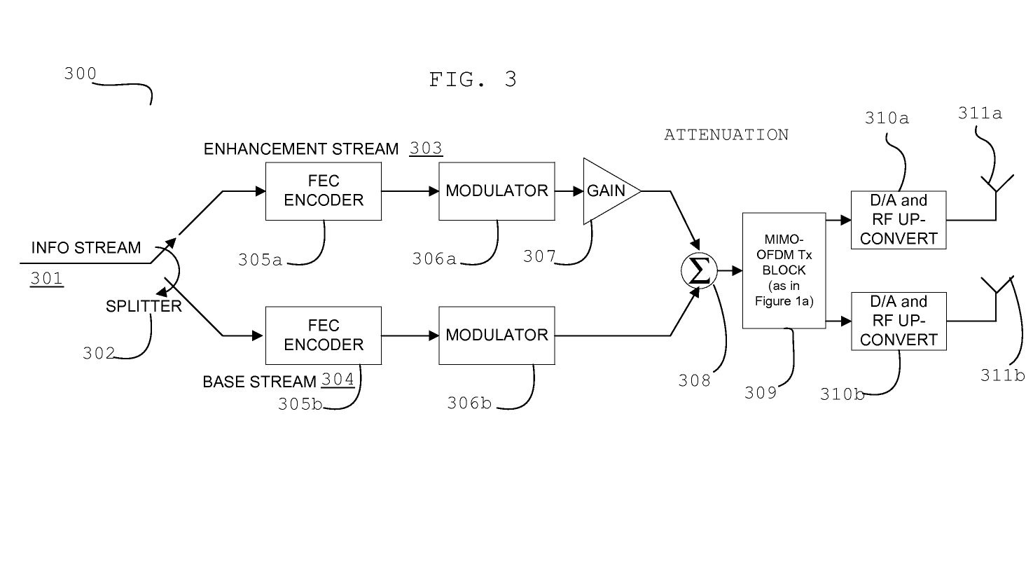

Referring now to FIG. 1A, there is shown a block diagram of a typical MIMO-OFDM transmitter 100. In FIG. 1A, a digital information stream 1 is provided to a FEC encoder 2. The digital information stream 1 may be generated from a digital source or digitized from an analog source (not shown). The FEC encoder 2 is not required for the practice of the embodiments, but an encoder such as FEC encoder 2 is typically included in order to improve system performance and/or reduce the amount of transmitted RF power needed to achieve acceptable system performance. The FEC encoder 2 is followed by modulator 3 that modulates the information stream to generate data symbols. A modulation scheme of modulator 3 is not restricted and may include an m-phase shift keying (m-PSK) scheme or an m-quadrature amplitude modulation (m-QAM) scheme.

The encoded and modulated symbols enter a MIMO-OFDM transmitter block 4. Serial to parallel splitter 5 splits the symbols among a paths (i.e., among the plurality of antennas), the symbols in each path being substantially identical immediately after splitter 5.

The symbols may be transmitted on multiple sub-carriers. Each sub-carrier may be processed by a plurality of MIMO processing blocks 6, each MIMO processing block 6 processing the symbols destined for a separate antenna. Typically, each MIMO processing block 6 modifies the transmitted symbol in amplitude and phase, for the respective channel as part of a MIMO algorithm in order to provide a desired transmission pattern. In one embodiment, each MIMO processing block 6 is controlled by a control signal provided by channel estimator 7, which may be based on feedback from the receiver. The control signal may be calculated from the channel matrix for that sub-carrier. For example, at the m-th subcarrier, the transmitter 100 may multiply the symbol at the n-th transmit antenna by the n-th element of the leading left singular vector of a channel matrix C(m).

Referring to FIGS. 1A and 1B, the transmitter 100 is designated as “station A” and the receiver 150 is designated as “station B”, for the benefit of the mathematical notation presented herein. Station A and station B, respectively have a plurality of a and b antenna elements 11 and 111. The energy transmitted from the transmitter 100 to the receiver 150, shown in aggregate as wireless channel 12, travels over individual RF channels (not shown) from transmit antenna j of A to receive antenna i of B, and the channel at the m-th sub-carrier for each of these individual RF channels is designated by cᵢⱼ(m), where “m” is the sub-carrier index. At Station B, the scalar channels cᵢⱼ(m) are collated into a b×a matrix, C(m), the ij^{th} element of which is cᵢⱼ(m). Usage of channel matrix C(m) to adjust each of the MIMO processing blocks 6 will be described later below.

After each transmit subcarrier has been adjusted by MIMO processing block 6, based on the channel matrix, a pilot insertion block 8 inserts a pilot signal on the signal destined for each transmit antenna. The pilot signal may be a sequence of modulated symbols (e.g., PSK or QAM) that occupy certain sub-carrier slots. The sequence of symbols that comprise the pilot and the sub-carrier slots they occupy may be known to the receiver. The sub-carrier slots that are occupied by pilot symbols may not also be occupied by traffic symbols. The sub-carrier slots that carry pilot symbols for a given transmit antenna may be distinct from the sub-carrier slots that carry pilot symbols for any other transmit antenna. Increasing the number of transmit antennas causes the pilot overhead to increase, because each transmit antenna demands multiple sub-carrier slots, i.e., bandwidth, in order to carry the transmit antenna's pilot signal. In an example operation, the modulated traffic symbols may be lined up in a vector, and the pilot (itself a vector of modulated symbols) inserted. Each modulated symbol's position within said vector corresponds to a certain sub-carrier. For example, if the sub-carrier spacing is 10 kHz, then the first symbol of said vector is destined to be transmitted at 0 Hz, the second symbol of said vector is to be transmitted at 10 kHz, the third symbol at 20 kHz, and so on. Thus, the vector of symbols at the transmitter spans the entire available bandwidth.

In an example embodiment, after the pilot is inserted, the digital frequency-domain transmit signal of each channel may be efficiently converted to a digital time-domain transmit signal using an Inverse Fast Fourier Transform (“IFFT”) operation 9 for each subcarrier. The IFFT operation 9 converts the vector of modulated symbols into a time-domain transmit signal. In one configuration a single IFFT operation that sequentially services the IFFT for each antenna may be used. In another configuration, the number of IFFT blocks utilized may be lesser than the number of antennas. Likewise, the other blocks (e.g., “MIMO Transmit Processing”) along the parallel arms of FIG. 1A may be implemented as multiple simultaneously running entities, or a single block that sequentially serves all the antennas. Clearly the same principle applies to the parallel arms of FIG. 1B.

The digital time-domain transmit signal may then be converted to an analog signal by use of a digital to analog (D/A) converter, and upconverted to the RF frequency using block 10. The RF signal may then be passed to one of a plurality of transmit antenna elements 11 for wireless transmission over wireless channel 12 (not shown) to a receiver. The plurality of transmit antenna elements 11 form an array that produces a composite phased array transmission response.

Referring now to FIG. 1B, there is shown a block diagram of a MIMO-OFDM receiver 150 designed to be compatible with MIMO-OFDM transmitter 100. Receiver 150 generally performs operations which are reversed from the operations performed by transmitter 100. For example, MIMO processing 106 for each received subcarrier, may be performed by multiplication of the received symbol at a certain sub-carrier by the leading right singular vector of the channel matrix at that sub-carrier.

Referring again to FIG. 1B, a description of received signal processing will be described below by reference to a single RF signal received by a single receive antenna element 111, insofar as this description also applies to processing of other RF signals by the other receive antenna elements. Each of the plurality of receive antenna elements 111 receives a composite signal transmitted by the plurality of transmit antennas 11, representing the phased array response of the transmit antenna array. Block 110 operates to downconvert the RF signal to an intermediate frequency (IF) signal and convert the downconverted IF signal from an analog signal into a digital signal. The downconverted digital IF signal may be provided to MIMO-OFDM Receive Block 104, in which the digital IF signal is passed through a Fast Fourier Transform (FFT) 109. A pilot may be removed from each subcarrier by the Pilot Removal block 108, and the removed pilot may be provided to channel estimator 107 in order to estimate the channel response matrix C(m) as described below.

The channel response matrix C(m) may be provided to transmitter 100 via feedback channel 112. The feedback channel 112 may be a separate communications channel, or may be included within the overhead portions of a link in the reverse direction (not shown) from Station B to Station A. The channel response matrix C(m) may also be provided to a plurality of MIMO Receive Processing blocks 106 within the MIMO-OFDM receive block 104, ordinarily one MIMO Receive Processing block 106 per received subcarrier. The transmitter 100 and receiver 150 typically both use the channel matrix C(m) (or an estimate of C(m)) at each of the N_{c} values taken by m. In other words, as the m-th sub-carrier is characterized by a channel matrix C(m), the MIMO processing done at transmitter and receiver for subcarrier m=19 depends on the matrix C(19), which in general will be different from the MIMO processing done at transmitter and receiver for subcarrier m=39 (say), which depends on C(39).

The plurality of MIMO Receive Processing blocks 106 operate at least to adjust the complex weighting (i.e., amplitude and phase) of each subcarrier, the weightings adjusted at least to form a desired composite received phase array antenna response from the plurality of receive antenna elements 111. The weighted subcarriers may be provided to summation block 113 which performs a vector addition of each of the subcarriers. The vector addition may be performed across the b receive antenna elements. Thus, the received symbols at antennas 1 through b at sub-carrier 1 get added together; the received symbols at antennas 1 through b at sub-carrier 2 get added together; the received symbols at antennas 1 through b at sub-carrier 3 get added together, and so on. The output of summation block 113 may be an N_{C}-long vector, which the parallel-to-serial converter 105 serializes. The serial digital data stream may be provided to demodulator 103, which removes the modulation added in the transmitter 100 by modulator 3, to produce a stream of demodulated symbol characters. The demodulated symbol characters are provided to FEC decoder 102, which decodes (i.e., applies error correction) using the encoding bits or symbols added by FED encoder 2 in the transmitter 100. The decoded data stream may then be provided to external baseband processing equipment (not shown) via the received information stream 101.

Channel estimation typically is achieved by having each transmit antenna send pilot sub-carriers at frequencies separated by the coherence bandwidth of the channel. Pilot sub-carriers are tones that are known to the receiver (and hence carry no information). Each transmit antenna uses a different set of pilot sub-carriers. The receiver uses the received pilot tones to arrive at an estimate of the channel.

Typically, the coherence bandwidths and times of wireless channels for common wireless technologies (e.g., cellular, WiFi, WiMax, etc.) cause approximately 12%-15% of the subcarriers to be dedicated to a pilot signal. Since pilot signals are non-information bearing, the bandwidth devoted to pilot signals is an overhead cost that linearly increases with the number of transmit antennas, and thereby proportionately reduces the bit-rate supportable by the MIMO system. The percentage of bandwidth devoted to pilot signals could be reduced by accurate channel sounding in MIMO systems, thereby reducing the number of pilots used.

An embodiment reduces the amount of bandwidth used for channel estimation by the repeated application of a procedure known as Frequency Domain Interpolation (“FDI”). The FDI procedure may be employed at the receiver for: (1) obtaining an initial wide-band channel estimate; and (2) fine-tuning the channel estimate with one or more later iterations.

In some embodiments, frequency domain interpolation may be performed for most or all elements of the channel matrix C. The FDI method is described below for one element “c” of the channel matrix, but it should be understood that the procedure may apply to all elements of C. The notation herein will use c (or C), without reference to sub-carrier, to denote the entire wide-band channel. Reference to a channel at a particular sub-carrier m will be by use of the notation c(m) (or C(m)).

In an example embodiment, the receiver knows the predetermined locations of the pilot sub-carriers for each transmit antenna, based on a predetermined arrangement. The locations of the pilot sub-carriers may be denoted by m₁, m₂ . . . m_{P}, where P denotes the total number of pilot sub-carriers per transmit antenna. Note that the indices m₁, m₂ . . . m_{P} generally may be different for each transmit antenna. For example, a first transmit antenna may use the sub-carriers indexed by m₁=1, m₂=8, m₃=16 . . . , while a second transmit antenna may use sub-carriers indexed by m₁=2, m₂=9, m₃=17, and so forth.

Referring now to FIG. 2, there is shown a flowchart describing an example frequency domain interpolation method. At step 201, a receiver creates a vector of length N_{C} for each transmit-receive antenna pair, the vector having zeros for all elements except for elements located at the indices m₁, m₂, . . . , m_{P}. At the indices m₁, m₂, . . . , m_{P}, the vector is assigned the value of symbols received by the corresponding sub-carrier (for example, at indicia m₁, the vector is assigned the value of rₘ₁, which is the symbol received at sub-carrier m₁). The symbol received at some sub-carrier location, for instance m₃, may be the pilot symbol transmitted at that location multiplied by the channel response c(m₃) at that location and corrupted by additive noise. Symbolically, the receiver forms the vector r, given by

r=[0, . . . , 0, rₘ₁, 0, . . . , 0, rₘ₂, . . . , r_{mP}, 0, . . . , 0]

where rₘ₁, rₘ₂, . . . , r_{mP} are received symbols at sub-carriers m₁, m₂, . . . , m_{P}. Next, at step 202, an IFFT may be performed on vector r, producing a resulting vector ifft(r). In step 203, all but its lowest k elements of the vector ifft(r) are assigned a value of zero (i.e., “zeroed”), producing a new vector, “R”. The value of k is a predetermined constant value, k being a design parameter known as a cyclic prefix that is related to the expected multipath spread of the channel. In step 204, the channel estimate ĉ may be calculated as the FFT of R: ĉ=FFT(R).

The following describes an example operation of obtaining an accurate channel sounding via hierarchical modulation. The transmitter shown in FIG. 1A, provides a single encoded-and-modulated data stream to MIMO-OFDM transmitter block 4. In contrast, an embodiment of a transmitter shown in FIG. 3 splits the incoming bit-stream into two signal streams, termed herein as the “base stream” and the “enhancement stream,” and separately encodes and modulates the two streams, prior to providing them to MIMO-OFDM transmitter block 309, which may be substantially similar to the MIMO-OFDM transmitter block 4 of the transmitter of FIG. 1A. The embodiments will be described in FIG. 3, but it will be understood that the invention is not limited to these embodiments.

Referring now to FIG. 3, there is shown a block diagram of an example transmitter 300. Various components of transmitter 300 may be embodied as separate components or combined in a single processor of transmitter 300. A digital information stream 301 is supplied to transmitter 300. A switch 302 within transmitter 300 operates to split and to switch the digital information stream 301 into the enhancement stream 303 and the base stream 304. The information stream 301 may be switched in any proportion between supplying the enhancement stream 303 and the base stream 304. For instance, data may be split approximately equally; or data may be switched such that lower priority data or higher bit-rate data is routed to the enhancement stream 303; etc. In other words, information deemed more important may be sent on the base stream and information deemed less important may be sent on the enhancement stream. For example, a rough rendering of an image may be sent on the base stream and finer details of that image may be sent on the enhancement stream. Depending on the application, switch 302 may operate on a bit-by-bit basis, or may linger at each position to allow a block of bits to be switched. Both the enhancement stream 303 and the base stream 304 are then typically applied to FEC encoders 305a and 305b, respectively. FEC encoders 305a and 305b may utilize different encoding schemes. In some embodiments, the encoders may utilize a same encoding scheme. As with conventional transmitters, the FEC encoders 305a, 305b are not required for the practice of the embodiments, but encoders such as FEC encoder 305a, 305b are typically included in order to improve system performance and/or reduce the amount of transmitted RF power needed to achieve acceptable system performance.

After streams 303, 304 are encoded, they may be provided to modulators 306a, 306b respectively. Each modulator may utilize a different modulation scheme or the same modulation scheme. The modulation scheme is not restricted and may include an m-phase shift keying (m-PSK) scheme or an m-quadarture amplitude modulation (m-QAM) scheme. After modulation, an attenuation block 307 may be applied to one data stream. The embodiment of FIG. 3 shows attenuation block 307 applied to the enhancement stream 303, but alternatively the attenuation could be applied instead to base stream 304. The attenuation block 307 could also be replaced by a gain. In another configuration there could be separate but different attenuation blocks and/or gain blocks on the two streams, configured to provide a power difference between the enhancement stream 303 and the base stream 304.

In one embodiment, the attenuation block 307, as shown in FIG. 3 on the enhancement stream 303, allows a differential power between the base stream 304 and enhancement stream 303. This differential power may be referred to herein as an “E/B-ratio.” An E/B-ratio in the range of ½ to ⅓ (expressed as a linear ratio) may be used, but E/B ratios outside this range may also be usable. A range of ½ to ⅓ (linear) corresponds to a power difference of approximately 6 dB to 9.5 dB on a logarithmic scale. As the E/B-ratio becomes smaller the enhancement stream has lesser power relative to the base stream. This may necessitate usage of a stronger code on the enhancement stream. The enhancement stream is typically lower in power than the base stream. On the other hand, a small E/B-ratio results in a better channel estimate, which may contribute to better overall performance. A desired E/B-ratio may be chosen based on design simulations. For example, for a given situation (i.e., channel characteristics), an E/B ratio and a pair of FECs that satisfy the target transmission rate may be chosen. The transmit power needed to achieve the desired error rate may be checked. The E/B ratio may then be changed, which may mean a new pair of FECs. The transmit power needed to achieve the desired error rate may be checked again. At the conclusion of such a simulation study, an E/B ratio and a pair of FECs that minimizes the transmit power at the desired error rate may be obtained. The preferred E/B ratio may vary from one system to another, or may vary due to changes in the channel characteristics. If the E/B ratio is to vary dynamically with the channel then the current value of the E/B-ratio may need to be communicated by Station A to Station B.

Next, the enhancement stream 303 and the base stream 304 are combined in a summer 308. The output of summer 308 may be provided to a MIMO-OFDM transmitter block 309, which may be substantially similar to the MIMO-OFDM transmitter block 4 of the transmitter of FIG. 1A.

The output of MIMO-OFDM transmitter block 309 includes a plurality of subchannels, similar to that shown in FIG. 1A. Each output subchannel may be provided to a digital-to-analog (D/A) converter and RF upconverters 310a, 310b. Blocks 310a, 310b may be substantially similar to block 10 of FIG. 1A. Each of RF upconverters 310a, 310b converts an analog IF signal produced by the D/A into an RF signal, suitable for transmission by transmit antennas 311a, 311b.

Referring now to FIG. 4, there is shown the block diagram of a receiver 400 configured to receive and process the RF signals produced by transmitter 300. Various components of receiver 400 may be embodied as separate components or combined in a single processor of receiver 400. Receiver 400 is designed to recover both the transmitted enhancement stream 303 and the transmitted base stream 304 using an iterative design.

Referring again to FIG. 4, an RF signal is received by a plurality of receive antennas 401. The output of each receive antenna may be provided to an RF downconverter and analog to digital (A/D) converter 402, which converts the received RF signal into an IF signal and then further digitizes it.

The output of each converter 402 may be provided to a MIMO-OFDM Receiver block 403. Receiver block 403, which is substantially similar to the MIMO-OFDM Receiver block 104 of FIG. 1B combines, for each sub-carrier, the received signals from several antennas in a way that improves the received signal (e.g., an improved signal-to-noise ratio). As discussed earlier, this may be accomplished by usage of the singular value decomposition of the channel matrix, an estimate of which is provided by the channel estimator 408.

The channel estimator 408 may produce a wide-band (in terms of frequency) estimate of each element of the channel matrix, using the following example steps:

(1) Apply FDI to the vector of pilot observations 414, produced from the MIMO-OFDM Receiver block 403 (i.e., “true pilots” or “dedicated pilots”), in order to calculate an initial coarse channel estimate ĉ_{P}. This coarse estimate is used to produce an initial recovery of the base stream.

(2) Apply FDI to the symbols generated by re-encoding and re-modulating the initial recovery of the base stream bits, in order to calculate another channel estimate ĉ_{D}.

(3) Linearly combine ĉ_{P} and ĉ_{D} to get the fine channel estimate ĉ, given by the following relationship:

ĉ=βĉ_{P}+(1−β)\hat{c}_{D}, where |β|<1

In an embodiment, the factor β weighs the relative contributions due to ĉ_{P} and ĉ_{D}, and is a design parameter that depends on the density of true pilots and the power level of the enhancement stream. In an embodiment, the factor β may initially be set to 0.5, and then fine-tuned upwards if the ratio of the number of pilot sub-carriers per transmit antenna to the total number of sub-carriers is more than approximately 10%. In another embodiment, if the E/B-ratio is set to approximately ½ or lower, then β may be fine-tuned downwards to below 0.5.

The channel estimate produced by the channel estimator 408 may be fed back to the transmitter 300 via feedback mechanism 416 for MIMO pre-coding of the transmitted symbols in the MIMO-OFDM transmitter block 309. Additionally the channel estimate may also be provided to the MIMO-OFDM receive block 403 via interface 415, and used within the MIMO-OFDM receive block 403 to produce an improved signal to noise ratio (“SNR”) for the received signals compared to the signal to noise ratio produced by a system using non-hierarchical transmission. This is because the channel estimate ĉ is a more precise estimate of the true channel than either ĉ_{P} or ĉ_{D}. A “conventional” i.e., non-hierarchical transmission system only uses ĉ_{P}. The channel estimate produced by the channel estimator 408 may also be provided via interface 418 and used to remove the base stream 409 from the received signal, in order to facilitate recovery of the enhancement stream 412.

In an embodiment, the MIMO-OFDM Receiver block 403 also produces an output 419 which, similarly to FIG. 1B, is the serialized vector summation of each received and processed subcarrier. Output 419 may be provided to a base stream demodulator 404. Base stream demodulator 404 uses the symbol produced by the MIMO-OFDM block 403 and produces soft decisions for the bits of the base stream, i.e., produces likelihoods that each bit represented by a symbol of the base stream is a 1 or a 0. When computing likelihoods for the base stream, the enhancement stream may be treated as noise with a variance proportional to the EB-ratio.

The output of base stream demodulator 404 may be provided to base stream decoder 405. This may be an FEC decoder that reverses the actions of the base stream FEC encoder 305b used in transmitter 300. The output of base stream decoder 405 is the recovered base stream bits 409.

The example operation of receiver 400 is now described in greater detail. The base stream 409 is recovered first by the base stream demodulator 404 and base stream decoder 405.

Next, in order to recover the enhancement stream 412, the base stream 409 needs to be removed from the received signals. In one embodiment, base symbols provided by the base stream decoder 405 may be re-encoded by base stream re-encoder 406 and re-modulated by base stream re-modulator 407. The base stream re-encoder 406 and base stream re-modulator 407 replicate the actions of the encoder 305b and modulator 306b within the base-stream arm 304 of the transmitter 300, and re-create the base symbol stream as it existed within the transmitter 300 just prior to addition to the enhancement stream 303 at summer 308. The base symbols thus re-created may be provided as a pseudo-pilot stream to the channel estimator 408, to improve the initial channel estimate formed by the true (“dedicated”) pilots (improved in the sense that the channel estimate ĉ formed by using both true pilots and the pseudo-pilot stream is closer to the actual channel that the channel estimate ĉ_{P} formed by using only the true pilots).

The effect of the channel upon the re-created base stream may be simulated by using multiplier 413 to multiply the re-created base stream provided by re-modulator 407 with the channel estimate provided by interface 418. The “effect of the channel” refers to the shift in amplitude and phase that a transmitted symbol suffers. Thus it refers to fading but not to interference. The shift in amplitude and phase is modeled by representing the channel between a given transmit-receive pair and a given sub-carrier by a complex number that multiplies the transmitted symbol. Both 414 and 415 represent estimates of the channel, with 415 being a (much) better estimate than 414. Inasmuch as they are estimates of the channel, multiplying 415 by the re-modulated stream 407 simulates the effect of the base stream traveling through the channel.

The base stream, as processed using the channel estimate by multiplier 413, may then be subtracted from the output of the MIMO-OFDM receiver block 403 by use of summer 417, to provide a stream that becomes the enhancement stream 412 as described below.

The output of summer 417 may be provided as an input to an enhancement stream demodulator 410. The enhancement stream demodulator 410 produces soft decisions (i.e., bit likelihoods) for the enhancement stream, assuming that the only noise source is Gaussian thermal noise.

The output of the enhancement stream demodulator 410 may be provided to an enhancement stream decoder 411. This is an FEC decoder that reverses the actions of the FEC encoder 305a used on the enhancement-stream arm 303 of the transmitter 300. The output of the enhancement stream decoder 411 is the recovered enhancement stream bits 412.

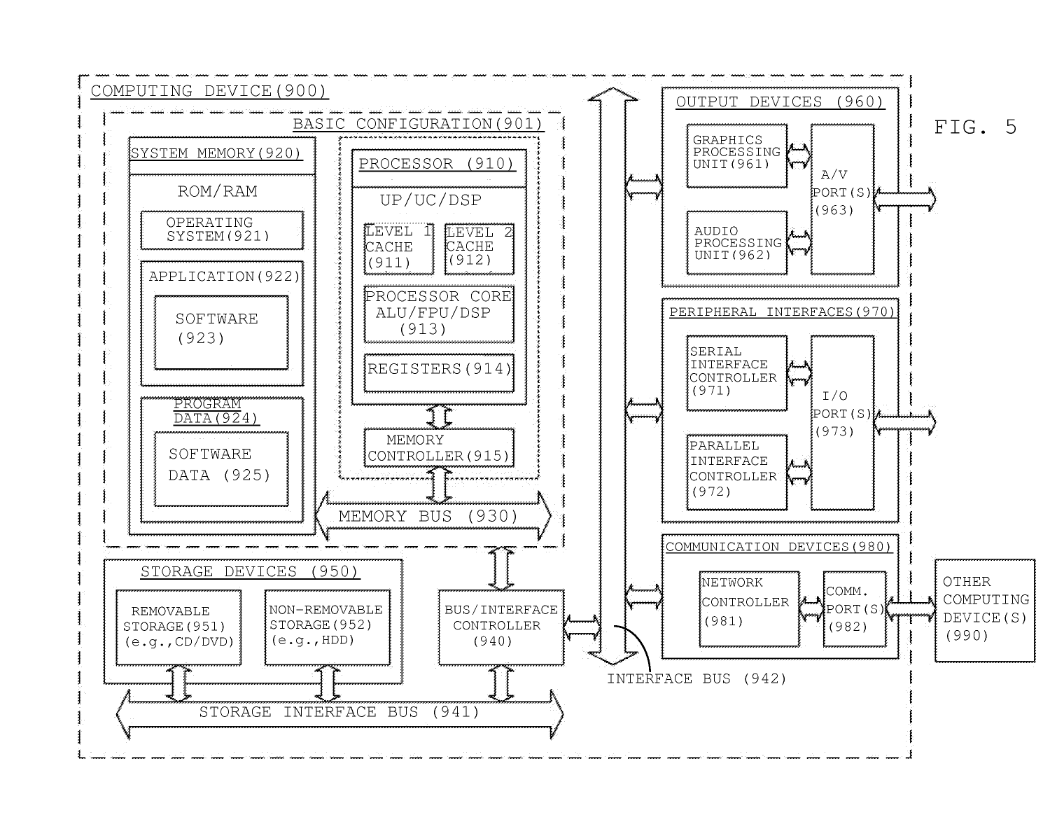

At least some of the embodiments presented above are realizable in a computing device configured to transmit/receive the data communication, and/or perform the calculations/estimations described herein. FIG. 5 is a block diagram illustrating an example computing device 900 that is arranged for obtaining an accurate channel sounding via hierarchical modulation in accordance with the present disclosure. In a very basic configuration 901, computing device 900 typically includes one or more processors 910 and system memory 920. A memory bus 930 may be used for communicating between the processor 910 and the system memory 920.

Depending on the desired configuration, processor 910 may be of any type including but not limited to a microprocessor (μP), a microcontroller (μC), a digital signal processor (DSP), or any combination thereof. Processor 910 may include one more levels of caching, such as a level one cache 911 and a level two cache 912, a processor core 913, and registers 914. An example processor core 913 may include an arithmetic logic unit (ALU), a floating point unit (FPU), a digital signal processing core (DSP Core), or any combination thereof. An example memory controller 915 may also be used with the processor 910, or in some implementations the memory controller 915 may be an internal part of the processor 910.

Depending on the desired configuration, the system memory 920 may be of any type including but not limited to volatile memory (such as RAM), non-volatile memory (such as ROM, flash memory, etc.) or any combination thereof. System memory 920 may include an operating system 921, one or more applications 922, and program data 924. Application 922 may include software 923 that is arranged to performed the functions (e.g., MIMO processing, channel estimations, etc.) as described herein including those described with respect to the flowchart of FIG. 2. Program Data 924 may include software data 925 that may be useful for operation with software 923. In some embodiments, application 922 may be arranged to operate with program data 924 on an operating system 921 such that accurate channel sounding may be obtained. This described basic configuration is illustrated in FIG. 9 by those components within dashed line 901.

Computing device 900 may have additional features or functionality, and additional interfaces to facilitate communications between the basic configuration 901 and any required devices and interfaces. For example, a bus/interface controller 940 may be used to facilitate communications between the basic configuration 901 and one or more data storage devices 950 via a storage interface bus 941. The data storage devices 950 may be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 920, removable storage 951 and non-removable storage 952 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of device 900.

Computing device 900 may include one or more of the computer readable tangible mediums that may be configured to store computer executable instructions that when executed by processor 910 may perform the various operations/functions described herein.

Computing device 900 may also include an interface bus 942 for facilitating communication from various interface devices (e.g., output interfaces, peripheral interfaces, and communication interfaces) to the basic configuration 901 via the bus/interface controller 940. Example output devices 960 include a graphics processing unit 961 and an audio processing unit 962, which may be configured to communicate to various external devices such as a display or speakers via one or more A/V ports 963. Example peripheral interfaces 970 include a serial interface controller 971 or a parallel interface controller 972, which may be configured to communicate with external devices such as input devices (e.g., keyboard, mouse, pen, voice input device, touch input device, etc.) or other peripheral devices (e.g., printer, scanner, etc.) via one or more I/O ports 973. An example communication device 980 includes a network controller 981, which may be arranged to facilitate communications with one or more other computing devices 990 over a network communication link via one or more communication ports 982.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

1. A method, comprising:
receiving a combined signal comprising a first pilot reference and a hierarchical signal, the hierarchical signal comprising a modulated encoded base stream and a modulated encoded enhancement stream;
calculating a first channel estimate based on the first pilot reference;
recovering a base stream from the combined signal based on the first channel estimate;
calculating a second channel estimate based on the base stream as a second pilot reference;
combining the first channel estimate and the second channel estimate to produce a third channel estimate; and
recovering an enhancement stream from the combined signal based on the third channel estimate.

2. The method of claim 1, comprising:
demodulating and decoding the modulated encoded base stream from the combined signal;
re-encoding the base stream to form a re-encoded base stream; and
re-modulating the re-encoded base stream to form a re-modulated re-encoded base stream,
wherein the calculating the second channel estimate further comprises calculating the second channel estimate based on the re-modulated re-encoded base stream as a second pilot reference.

3. The method of claim 2, further comprising:
removing the re-modulated re-encoded base stream from the combined signal; and
demodulating and decoding the modulated encoded enhancement stream from the combined signal.

4. The method of claim 1, wherein the calculating the first channel estimate comprises applying a frequency domain interpolation to the first pilot reference to calculate the first channel estimate.

5. The method of claim 2, wherein the calculating the second channel estimate comprises applying a frequency domain interpolation to the re-modulated re-encoded base stream to calculate the second channel estimate.

6. The method of claim 1, wherein the first channel estimate and the second channel estimate are combined using the following equation:
ĉ=βĉ_{P}+(1−β)\hat{c}_{D}, where |β|<1,
wherein, ĉ is the third channel estimate, ĉ_{P} is the first channel estimate, ĉ_{P} is the second channel estimate, and β is a parameter that depends on a density of the first pilot reference and a power level of the modulated encoded enhancement stream.

7. An apparatus, comprising:
at least one apparatus configured to receive a combined signal comprising a first pilot reference and a hierarchical signal, the hierarchical signal comprising a modulated encoded base stream and a modulated encoded enhancement stream; and
a channel estimator configured to (a) calculate a first channel estimate based on the first pilot reference, (b) calculate a second channel estimate based on a base stream as a second pilot reference, wherein the base stream is recovered from the combined signal based on the first channel estimate, and (c) combine the first channel estimate and the second channel estimate to produce a third channel estimate, wherein an enhancement stream is recovered from the combined signal based on the third channel estimate,
wherein the apparatus is configured to receive a radio signal.

8. The apparatus of claim 7, further comprising:
a base stream demodulator configured to demodulate the modulated encoded base stream from the combined signal to form a demodulated encoded base stream;
a base stream decoder configured to decode the demodulated encoded base stream to form a demodulated decoded base stream;
a base stream re-encoder configured to re-encode the demodulated decoded base stream to form a re-encoded base stream; and
a base stream re-modulator configured to re-modulate the re-encoded base stream to form a re-modulated re-encoded base stream,
wherein the channel estimator is configured to calculate the second channel based on the re-modulated re-encoded base stream as a second pilot reference.

9. The apparatus of claim 8, further comprising:
a summer configured to subtract the re-modulated re-encoded base stream from the combined signal;
an enhancement stream demodulator configured to demodulate the modulated encoded enhancement stream from the combined signal to form a demodulated encoded enhancement stream; and
an enhancement stream decoder configured to decode the demodulated encoded enhancement stream to form a demodulated decoded enhancement stream.

10. The apparatus of claim 7, wherein the channel estimator is configured to calculate the first channel estimate by applying a frequency domain interpolation to the first pilot reference.

11. The apparatus of claim 8, wherein the channel estimator is configured to calculate the second channel estimate by applying a frequency domain interpolation to the re-modulated re-encoded base stream.

12. The apparatus of claim 7, wherein the first channel estimate and the second channel estimate are combined using the following equation:
ĉ=βĉ_{P}+(1−β)\hat{c}_{D}, where |β|<1,
wherein, ĉ is the third channel estimate, ĉ_{P} is the first channel estimate, ĉ_{D} is the second channel estimate, and β is a parameter that depends on a density of the first pilot reference and a power level of the modulated encoded enhancement stream.

13. A computer readable tangible medium comprising computer executable instructions for:
calculating a first channel estimate based on a first pilot reference of a combined signal, the combined signal comprising the first pilot reference and a hierarchical signal, the hierarchical signal comprising a modulated encoded base stream and a modulated encoded enhancement stream;
recovering a base stream from the combined signal based on the first channel estimate;
calculating a second channel estimate based on the base stream as a second pilot reference;
combining the first channel estimate and the second channel estimate to produce a third channel estimate; and
recovering an enhancement stream from the combined signal based on the third channel estimate.

14. The computer readable tangible medium of claim 13, wherein the instructions further comprise instructions for:
demodulating and decoding the modulated encoded base stream from the combined signal;
re-encoding the base stream to form a re-encoded base stream; and
re-modulating the re-encoded base stream to form a re-modulated re-encoded base stream,
wherein the instructions for calculating the second channel estimate further comprise instructions for calculating the second channel estimate based on the re-modulated re-encoded base stream as a second pilot reference.

15. The computer readable tangible medium of claim 14, wherein the instructions further comprise instructions for:
removing the re-modulated re-encoded base stream from the combined signal; and
demodulating and decoding the modulated encoded enhancement stream from the combined signal.

16. The computer readable tangible medium of claim 13, wherein the instructions for calculating the first channel estimate further comprise instructions for applying a frequency domain interpolation to the first pilot reference to calculate the first channel estimate.

17. The computer readable tangible medium of claim 14, wherein the instructions for calculating the second channel estimate further comprise instructions for applying a frequency domain interpolation to the re-modulated re-encoded base stream to calculate the second channel estimate.
